(19) United States
(12) Patent Application Publication
(10) Pub. No.: US 2020/0361692 A1
(43) Pub. Date: Nov. 19, 2020

(54) Flexible Bags and Products Therein With Extended Shelf Life

(71) Applicant: Liqui-Box Corporation, Richmond, VA (US)

(72) Inventor: Adrian Ellis Jackson, Folsom, CA (US)

(21) Appl. No.: 15/931,897

(22) Filed: May 14, 2020

Related U.S. Application Data
(60) Provisional application No. 62/847,408, filed on May 14, 2019.

(51) Int. Cl. B65D 81/24; B65D 75/30; B65D 75/58; B65B 31/04; B65D 85/72; B32B 27/08; B32B 27/30; B32B 27/32; B32B 27/34; B32B 15/09; B32B 27/36; B32B 7/12; B32B 1/00; B65D 65/40; C12G 1/00

(52) U.S. Cl. CPC B65D 81/24; B32B 2439/46; B65D 75/5877; B65B 31/04; B65D 85/72; B32B 27/08; B32B 27/306; B32B 27/32; B32B 27/34; B32B 15/09; B32B 27/36; B32B 7/12; B32B 1/00; B65D 65/40; C12G 1/00; B32B 2270/00; B32B 2439/70; B65D 75/30

(57) ABSTRACT

This invention relates to extending shelf life of food product such as wine packaged in flexible bags. Oxygen transport into the wine through the flexible-bag walls reduces the shelf life of the product. Similarly, oxygen in air trapped in headspace of a flexible bag packaged with the food product such as wine eventually dissolves into the wine, and consequently diminishing its shelf life. This invention relates flexible bags that provide inert gas cavities around the wine and in the headspace above the wine, and the process of making such flexible bags, such that the total oxygen content inside an unfilled (with product) flexible bag is less than 10%.

### CROSS REFERENCE TO RELAYED APPLICATIONS

This application claims the benefit of U.S. Provisional Application No. 62/847,408, filed May 14, 2019, the entirety of which is incorporated herein for any and all purposes.

### TECHNICAL FIELD

This invention relates to extending shelf life of food product such as wine, packaged in flexible bags. Oxygen transport into the product through the flexible-bag walls can reduce the shelf life of the product. Similarly, oxygen in air trapped in headspace of a flexible bag packaged with the food product such as wine, partially or fully, may dissolve into the wine, thus shortening its shelf life. This invention relates to flexible bags that provide inert gas cavities around the wine and in the headspace above the wine, and the process of making such flexible bags, such that the total oxygen content inside a flexible bag, not yet filled with a product, is less than 10%.

### BACKGROUND

Generally, flexible bags or pouches are made from laminate films and filled with flowable materials. Laminate films, generally made from polyolefins, for packaging flowable materials are described in U.S. Pat. Nos. 4,503,102; 4,521,437; 5,206,075; 5,364,486; 5,508,051; 5,721,025; 5,879,768; 5,942,579; 5,972,443; 6,117,4656; 6256,966; 6,406,765; 6,416,833; and 6,767,599. These patents describe polymer blends to manufacture flexible packages for packaging flowable materials, which includes food packaging. These patents are incorporated herein by reference.

Flexible packaging, particularly for food, is subject to many demands. The packaging needs to be workable in such a way that the packaging material may be quickly placed around the item to be packaged using machinery. The packaging material must also be of such quality that it adequately stores the product before the opening the packaging. For packaging food products, this typically means that the packaging materials provide an oxygen barrier to maintain freshness. Oxygen negatively impacts the packaged product, in that, it often reduces the packaged product's shelf life and/or degrades the product: change in color, change in taste, or change in odor of the food packaged in the flexible-bag. According to one study by the French National Institute of Agricultural Research (IRA), an additional 1 mg of oxygen per liter of wine reduces its shelf life by one month. (See, FIG. 1).

Of the many sources of oxygen for a flexible bag, two important ones include: (1) total oxygen content in an unfilled bag; and (2) oxygen transmission from outside environment through the flexible bag walls and its dissolution into the food product such as wine. A reduction in oxygen transmission rate (OTR), as well as in the overall oxygen content of the flexible bag prior to its filling for packaging products, especially liquid products, is desired. For example, in aseptic packaging, an aseptic steam sterilization is used prior to filling the bags. Bags after steam sterilization show increased oxygen transmission rate. For storing wine in flexible packaging for a longer time, which is currently desired by the market—of 9-12 months—a process is needed for reducing the oxygen content of the bags before filling, and for reducing oxygen's ingress through the packaging after the filling process had taken place.

### SUMMARY OF THE INVENTION

This invention addresses the shelf-life and the product degradation issues differently. More specifically, this invention provides flexible-bags comprising inert-gas-filled cavities, in which, the oxygen concentration prior to the filling of the product in various cavities is less than 10%. This invention also relates to the process of making these flexible-bags, wherein the inert gas is introduced during the making of the flexible bags, and prior to the sealing of the edges of the flexible bags. It is the first time that the flexible-bag has been made that has closed cavities comprising inert gas, which were made during the flexible-bag manufacturing process, prior to filling of the product.

This invention relates to a flexible bag, for packaging a product to reduce the impact of oxygen on the product and/or to increase said product's shelf life:

wherein said flexible bag is sealed at the edges that form at least one cavity; wherein said flexible bag is sealed at the edges that form at least one cavity; wherein said flexible bag comprises at least one fitment in closed position on one side of said flexible bag for filling it with one of said products; wherein said flexible bag comprises at least one cavity that comprises a gas; wherein said gas comprises less than 10% oxygen before filling said flexible bag with one of said products; and wherein said flexible bag is made from polymeric films.

This invention also relates to the flexible bag recited above; wherein said bag comprises three cavities: a first cavity, a second cavity, and a third cavity; wherein said first cavity is defined by a first polymeric film layer and a second polymeric film layer; wherein said second cavity is defined by said second polymeric film layer and a third polymeric film layer; and wherein said third cavity is defined by said third polymeric film layer and a fourth polymeric film layer; wherein said first, second, third, and fourth polymeric film layers are coplanar, and sealed at the edges; wherein said second cavity is central to said first cavity and said third cavity; wherein said second cavity is used for filling said product; wherein said second cavity is connected to said fitment for filling and dispensation of said product; and wherein said three cavities, prior to filling of said product, comprise of said gas.

This invention also relates to the process for preparing a flexible bag as recited above, comprising the steps of: introducing a portion of said gas through at least one main tube into said at least one cavity from an external gas source during the continuous or stop start process of flexible bag-making; replacing, substantially, all air in said at least one cavity with said portion of said gas; sealing said at least one cavity to trap said gas inside; and repeating the above steps for the next flexible bag in the continuous or stop start process of flexible bag-making.

In one embodiment, this invention also relates to a process for preparing a flexible bag as recited above, comprising the steps of: introducing a portion of said gas of said first cavity through a first main-tube into said first cavity from an external gas source during the continuous process of flexible bag-making; introducing a portion of said gas of said second cavity through a second main-tube into said second cavity from an external gas source during the continuous process of flexible bag-making; introducing a portion of said gas of said third cavity through a third main-tube into said third cavity from an external gas source during the continuous process of flexible bagmaking; replacing, substantially, all air in said three cavities with said portions of said gases corresponding to each cavity; sealing said three cavities to trap said gases inside; and optionally sweeping the air out or burping the pouch to again remove as much air/inert gas as possible; and repeating the above steps for the next flexible bag in the continuous process of flexible bag-making.

This invention also relates to a flexible bag, comprising a product, wherein said flexible bag is sealed at the edges that form more than one cavity; wherein said product is filled in only one cavity of said more than one cavity, the remaining cavities being non-filled cavities; wherein said flexible bag comprises at least one fitment in closed position on its one side, for dispensing said product from said flexible bag; wherein said non-filled cavities comprise a gas; wherein said gas comprises less than 10% oxygen; and wherein said flexible bag is made from polymeric films.

The flexible film and bags of the present invention are very suitable for the following: wine; beer; water; aerated water; soda; non-alcoholic wine coolers; energy drinks; fruit juices; vegetable juices; chemical and detergents. Chemicals also include oils, preferably the ones that are hygroscopic. For example, motor oils, lubricants, brake fluids, and hydraulic fluids. Other examples of chemicals include glycerol, ethanol, methanol, sulfuric acid, fertilizer chemicals, paints and coatings, adhesives, and salts.

### BRIEF DESCRIPTION OF DRAWINGS

FIG. 1 shows oxygen accumulation during filling of wine;

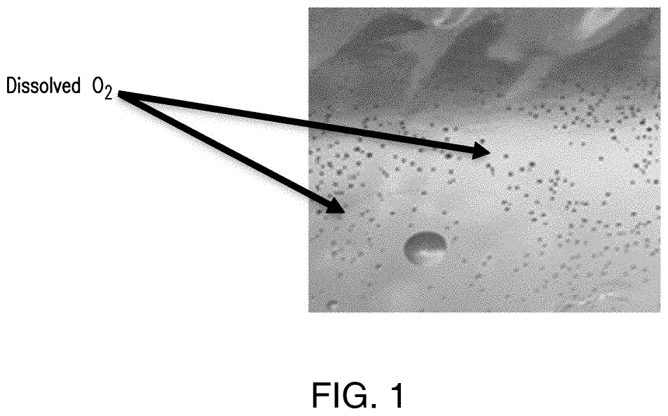

FIG. 2 shows a typical flexible bag packaged with wine;

FIG. 3 is a triple-cavity flexible bag of the invention;

FIG. 4 is the multiple-cavity flexible bag of the invention;

FIG. 5A shows various constructions of the single-cavity bag of the disclosure;

FIG. 5B shows various further constructions of the single-cavity bag of the disclosure;

FIG. 6 shows the process of the invention;

FIG. 7 shows the inert gas/nitrogen flow in the flexible bag cavities;

FIG. 8A shows the various tubes constructions that can be used to create an inert gas environment in bag cavities prior to edge sealing;

FIG. 8B shows the various tubes constructions that can be used to create an inert gas environment in bag cavities prior to edge sealing;

FIG. 9 shows the Residual Air Test procedure;

FIG. 10 depicts the general construction of a flexible bag wall of invention for improved properties at very high Relative Humidity %;

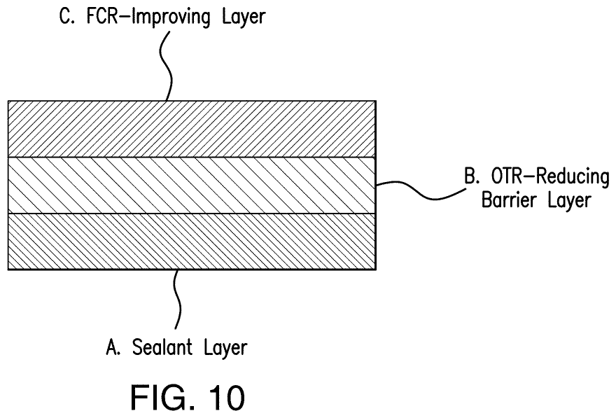

FIG. 11 depicts the Met-Flex film manufactured with thermally-laminated three layers;

FIG. 12 depicts the Met-Flex Film manufactured using extrusion lamination/coating process;

FIG. 13 depicts the Met-Flex film manufactured using extrusion lamination with co-extrusion multilayer technology;

FIG. 14 depicts the Met-Flex film manufactured using extrusion lamination with thermal lamination;

FIG. 15 depicts the Met-Flex film manufactured using adhesive lamination;

FIG. 16 depicts the Met-Flex film manufactured according to another aspect of the disclosure;

FIG. 17 shows an air cone in a bag; and

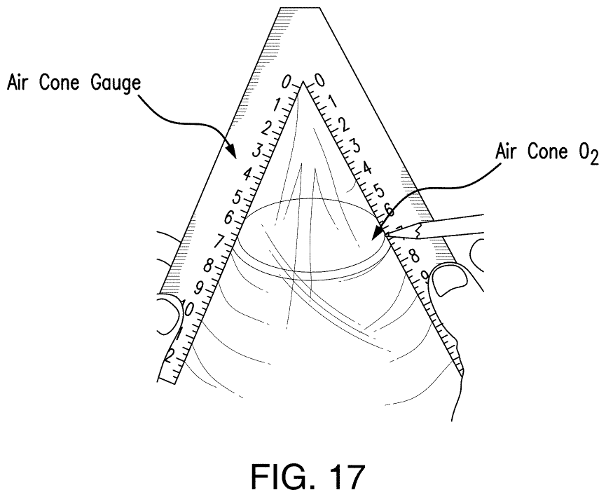

FIG. 18 shows a graphical representation of the life cycle oxygen management.

### DETAILED DESCRIPTION OF THE INVENTION

### I. Definitions

By “FCR” is meant flex-crack resistance.

By “OTR” is meant oxygen-transmission rate.

The terms “flexible bags,” bags, and “pouches” are used interchangeably.

By “flowable materials” is meant materials which are flowable under gravity or which may be pumped. Food products and ingredients in liquid, powder, paste, oils, granular or the like forms, of varying viscosity are envisaged. Normally such materials are not gaseous. But materials with gas bubbles, for example, are within the scope of the present invention. Materials used in for utility purposes, manufacturing, and medicine are also considered to fall within such materials.

### II. General Invention

The flexible film and bags of the present invention are suitable for packaging of products that may be impacted by exposure to oxygen, over time. Stated another way, the flexible film bags of the present invention are suitable for use in packaging of products where oxygen's impact on the product is to be reduced or avoided.

In the below description, edible, industrial, and other items are listed to provide a broad spectrum of products to which this invention can be applied, but the list is by no means exhaustive. Stated differently, this invention relates to packaged items that are in need from protection from oxygen.

The flexible bags of the present invention can be used for packaging, for example, the following:

beverages such as wine, beer, milk, a non-alcoholic beverage, an alcoholic beverage not including wine or beer, water, aerated water, soda; non-alcoholic wine coolers, energy drinks, fruit juices, vegetable juices—juice not including fruit or vegetable juice;

edible items or their precursors, such as sauces, mustard, ketchup, food dressings, cheese, sour-cream, yoghurt, mayonnaise, salad dressings, relish, oil, margarine, coffee concentrate, pastes, puree, ice cream mix, milk shake mix, preserves, emulsions, doughnut fillings, jellies, coffee beans;

freeze-dried food items such as powders; and

dried food items such as powders, for example, coffee and tea.

The flexible bags of the present invention can be used for packaging, for example, the following:

chemicals, detergents, non-edible oils, preferably the ones that are hygroscopic, for example, oils including motor oils, lubricants, brake fluids, and hydraulic fluids;

other examples of chemicals include glycerol, ethanol, methanol, sulfuric acid, fertilizer chemicals, paints and coatings, adhesives, salts, emulsions, caulking material, medicines, and materials used in manufacturing.

In another embodiment, this invention relates to a packaged flexible bag, comprising one of the above listed products.

Oxygen dissolved in the products, such as wine, in the flexible bag, is detrimental to the shelf life and degrades the packaged product. If the dissolved oxygen into the packaged liquid product increases, it stands to lose its character, for example, its taste or fragrance, and even its utility. The oxygen enters the products from the outside atmosphere, by penetrating through the flexible-bag walls.

The present invention addresses the problems caused by oxygen in products packaged in flexible bags. More specifically, the flexible bags of the present invention help minimize oxygen transport across film layers. This invention also relates to flexible bags packaged with products, which show reduction in oxygen transport from outside environment into the packaged product through the polymeric film layers of the flexible bag. This invention reduces the oxygen transport by providing inert-gas filled pockets or cavities encasing the product. This invention also relates to the process of creating inert-gas filled pockets or cavities in the flexible bag during the flexible bag manufacture in a dynamic fashion.

### II. A. Flexible Bags

In one embodiment, this invention relates to a flexible bag for packaging one of the following products: (A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent.

Wine, as a product packaged in flexible bag, is used as an example in the description below.

However, the invention relates to all products and product categories listed in this disclosure.

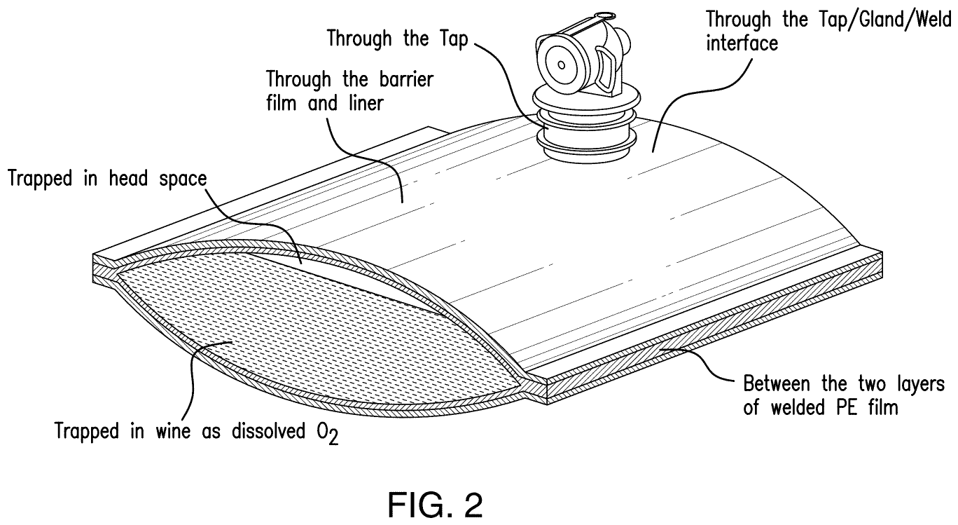

In FIG. 2, a flexible bag is filled with wine. It also shows the various sources from which oxygen can ingress and likely impact the wine quality. More specifically, the oxygen can transport into the product, for example wine, through the packaging materials during the filling process and the distribution process. Generally, the oxygen that can degrade the product such as wine comes from six identifiable sources:

(1) oxygen in air trapped in headspace of the packaged wine;

(2) oxygen in air from outside environment transporting through the flexible walls;

(3) oxygen in air trapped between the two flexible polymeric films on one or both walls of the bag;

(4) oxygen dissolved in wine;

(5) oxygen in air trapped in the dead-space of the dispensation fitment (tap); and

(6) oxygen in air from the outside atmosphere leaking into the product through the operation of the dispensation fitment, or the weld interface of the fitment with the flexible bag.

This invention relates to the oxygen in air trapped in headspace of the packaged wine; the oxygen in air from outside environment transporting through the flexible walls; and oxygen in air trapped between the two flexible polymeric films on one or both walls of the bag.

### II. A. 1. Three-Cavity Flexible Bag

In this embodiment of the invention, the flexible bag is in the unfilled state, or in filled state, for example packaged wine. FIG. 2 shows a typical construction of the flexible bag in a square or rectangular-shape that is filled with wine. The bag comprises two walls that are sealed at the four edges of the square or a rectangular construction thereby forming a cavity for packaging wine inside the cavity. Each wall is made of two polymeric films not laminated to each other. Thus, one additional cavity is formed within each wall; that is a total of two cavities in addition to the wine-packaging cavity. Stated another way, this flexible-bag embodiment comprises two walls, four polymeric films, and three cavities including the packaging cavity. Each polymeric film can be a single-layer or a laminate of multiple layers. By laminate is meant that the multiple layers of the polymeric film adhere to each other in a planar fashion. At least on one of the two walls is attached a dispensation fitment.

The three-cavity flexible bag in the unfilled state is sealed at the edges to form the central cavity for filling with a product such as wine. The dispensation fitment or tap is in a closed position. But prior to wine filling, instead of residual air trapped inside, the central cavity comprises mostly of inert gas that is less than 10% oxygen. In contrast, normal air has 20-21% oxygen and 78% nitrogen. Similarly, in the other two cavities, in between the two non-laminated polymeric films of the wall, instead of residual air trapped inside, it is the substantially inert gas that is trapped inside, such that the cavity gases comprise less than 10% oxygen.

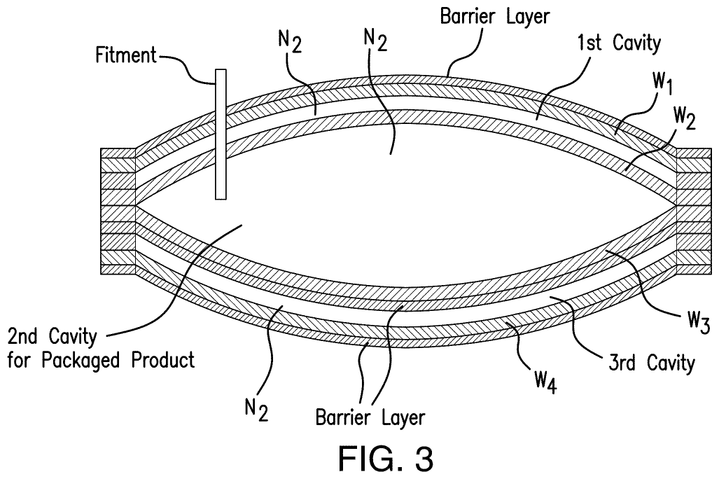

An exemplary triple-cavity bag is shown in FIG. 3. It has four flexible walls, W1, W2, W3, and W4. Cavity 1 is formed by walls W1 and W2. Cavity 2 is formed by walls W2 and W3. Cavity 3 is formed by walls W3 and W4. In one embodiment of the invention, walls W1, W2, W3, and/or W4 can be a single-layer, double-layer or multiple-layer film/s. In one embodiment of the invention, walls W1, W2, W3, and/or W4 can have at least one barrier layer. In another embodiment of the invention, the barrier layer is metalized, for example, Met-Flex. By Met-Flex is meant the film construction described infra in the Section titled “Polymeric Films—Various Embodiments,” and in the U.S. patent application Ser. No. 16/749,207, which is incorporated by reference herein.

An exemplary barrier layer is described infra. The single-cavity bag described infra shows several schematics of its exemplary embodiments especially as it relates to the variation in the wall films, and barrier layers. Those variations are incorporated herein for the walls of the triple-cavity flexible-bag. Preferably, at least one of those cavities is substantially filled with inert gas. In one embodiment, all cavities are filled with the substantially inert gas, that is less than 10% oxygen.

### II. A. 2. Multiple-Cavity Flexible-Bags

This invention also embodies a flexible bag that has total cavities from 2-10 in number. In other words, apart from the cavity for packaging wine, the walls could have 1-9 cavities. This invention encompasses the embodiment that has more cavities in one wall and less cavities in the other wall. In one embodiment, one wall does not have any cavity and is simply a single-layer or a multi-layer laminated film. The second wall can have all the cavities.

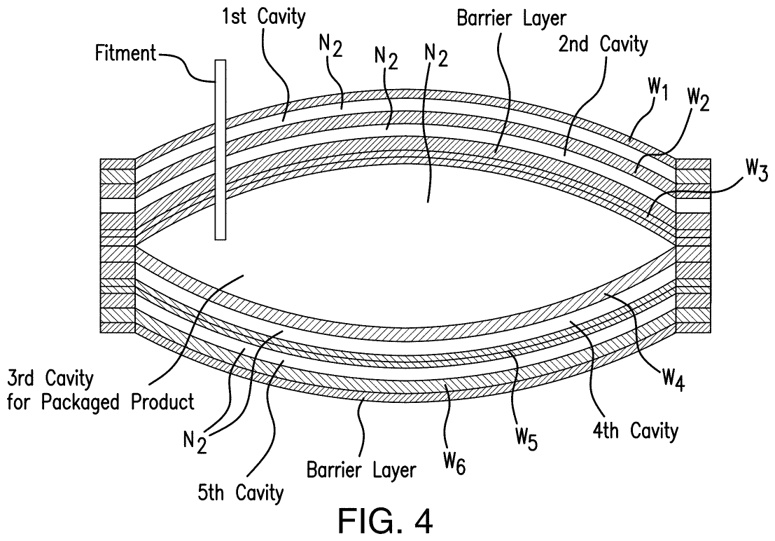

FIG. 4 shows the schematic of a five-cavity flexible bag of the present invention. It has six flexible walls, W1, W2, W3, W4, W5, and W6. Cavity 1 is formed by walls W1 and W2. Cavity 2 is formed by walls W2 and W3. Cavity 3 is formed by walls W3 and W4. Cavity 4 is formed by walls W4 and W5. Cavity 5 is formed by walls W5 and W6. In one embodiment of the invention, walls W1, W2, W3, W4, W5, and/or W6 can be a singlelayer, a double-layer, or a multiple-layer film/s. In one embodiment of the invention, walls W1, W2, W3, W4, W5, and/or W6 can have at least one barrier layer. In another embodiment of the invention, the barrier layer is METFLEX type. An exemplary barrier layer is described infra. The single-cavity bag described infra shows several schematics of its exemplary embodiments especially as it relates to the variation in the wall films, and barrier layers. Those variations are incorporated herein for the walls of the multiple-cavity flexible-bag. Preferably, at least one of those cavities is substantially filled with inert gas. In one embodiment, all cavities are filled with the substantially inert gas, that is less than 10% oxygen.

### II. A. 3. Single-Cavity Flexible Bag

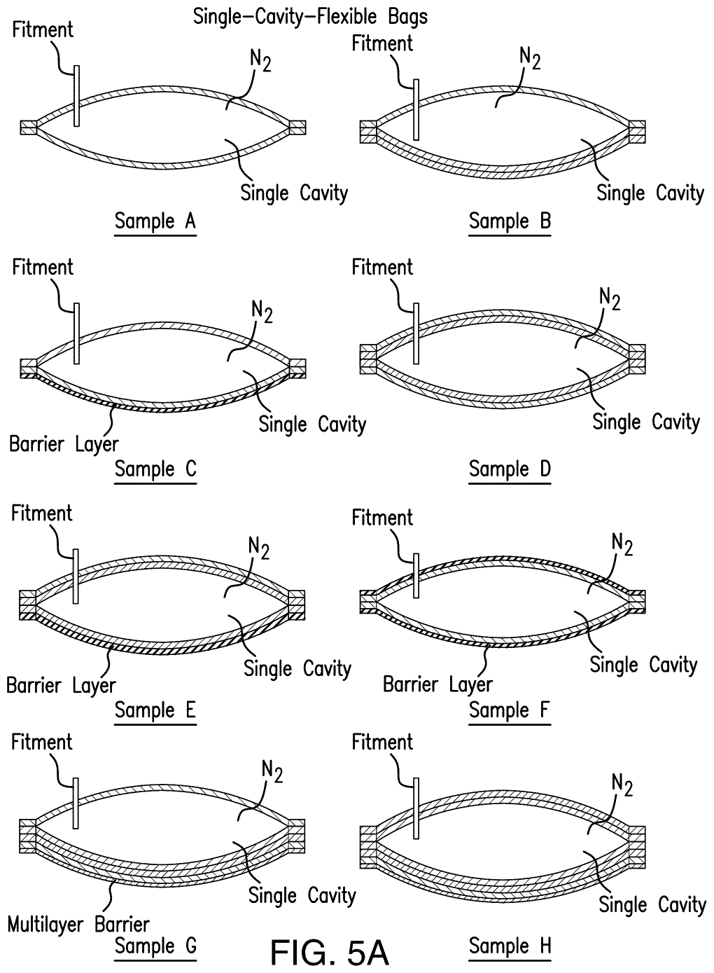

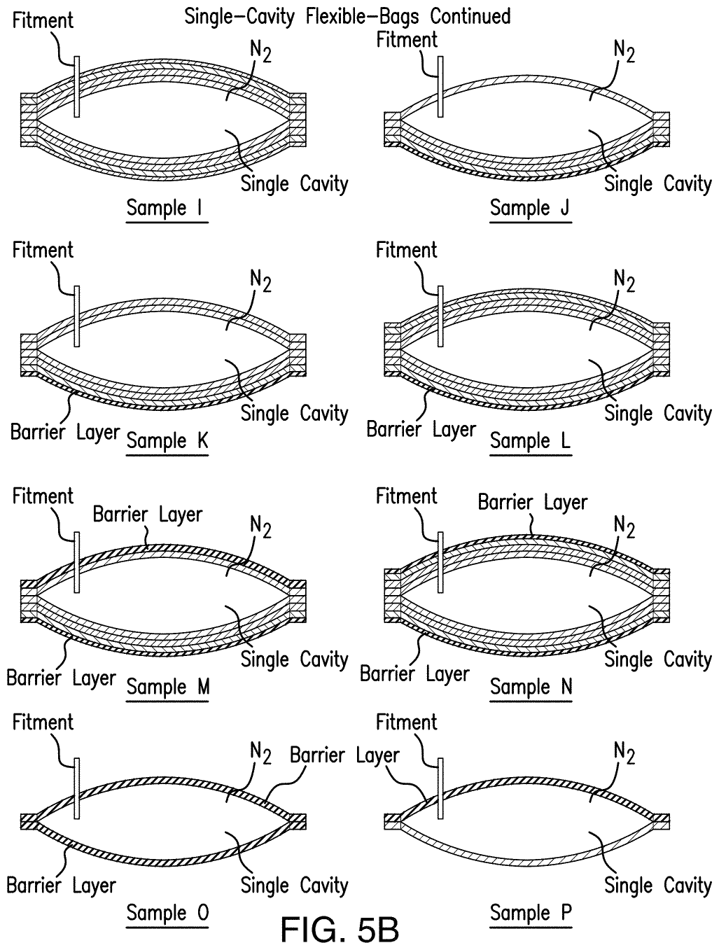

In this embodiment of the invention, the flexible bag comprises of two walls forming a single cavity, that is, the packaging cavity. The walls are made of single-layer polymeric film or multi-layer laminate polymeric film. The packaging cavity, in the unfilled state, comprises the substantially inert gas trapped inside, that which comprises less than 10% oxygen. In exemplary embodiments of the invention comprising the single-cavity bag, at least one wall of the bag is double-layer laminate, or a multi-layer laminate. In another set of exemplary embodiments, at least one wall of the bag is a double layer laminate or a multi-layer laminate, and at least one of those walls has an external barrier layer, for example, METFLEX type of a barrier layer. Exemplary barrier layers are described infra in this document. In FIG. 5 is shown some exemplary constructions of the single-cavity flexible bag. The bag characteristics are summarized in Table 1 below:

TABLE 1
Bag Characteristics

| | | | Wall 1 + | Wall 2 + |
|---|---|---|---|---|
| Id. | Wall 1 | Wall 2 | Barrier Layer | Barrier Layer |
| A. | Single Layer | Single Layer | No | No |
| B. | Single Layer | Double Layer | No | No |
| C. | Single Layer | Double Layer | No | Yes |
| D. | Double Layer | Double Layer | No | No |
| E. | Double Layer | Double Layer | No | Yes |
| F. | Double Layer | Double Layer | Yes | Yes |
| G. | Single Layer | Multiple Layer | No | No |
| H. | Double Layer | Multiple Layer | No | No |
| I. | Multiple Layer | Multiple Layer | No | No |
| J. | Single Layer | Multiple Layer | No | Yes |
| K. | Double Layer | Multiple Layer | No | Yes |
| L. | Multiple Layer | Multiple Layer | No | Yes |
| M. | Double Layer | Multiple Layer | Yes | Yes |
| N. | Multiple Layer | Multiple Layer | Yes | Yes |
| O. | Single Layer | Single Layer | Yes | Yes |
| P. | Single Layer | Single Layer | Yes | No |

### II. B. Polymeric Film Thickness

Each wall is made of one or more polymeric films. Each polymeric film is a single-layer film or a multi-layer laminated structure.

The thickness of the polymeric film is in the range of from about 25 μm to about 100 μm. Stated differently, the thickness of the polymeric can be in a range defined by any two numbers including the endpoints of such range, selected from the following number, in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

### II. C. Substantially Inert Gas

The substantially inert gas in one embodiment comprises less than or equal to 10% oxygen. In other embodiments, the oxygen concentration of the substantially inert gas is in the range defined by any two numbers given below, including the endpoints of such range: 0.0, 0.05, 0.1, 0.15, 0.2, 0.25, 0.3, 0.35, 0.4, 0.45, 0.5, 1.0, 1.5, 2.0, 2.5, 3.0, 3.5, 4.0, 4.5, 5, 5.5, 6.0, 6.5, 7.0, 7.5, 8.0, 8.5, 9.0, 9.5, and 10.

So, for example, in one embodiment, the substantially inert gas could comprise oxygen in the concentration range of 2.0-5.0%. In another embodiment, it could be 0.05 and 0.5%. The concentration could also be 0.1%.

In one embodiment, the other components of the substantially inert gas could comprise nitrogen, argon, helium, or a combination thereof. In one embodiment, the substantially inert gas is nitrogen in the concentration range defined by any two numbers given below, including the endpoints of such range: 90, 90.5, 91.0, 91.5, 92.0, 92.5, 93.0, 93.5, 94.0, 94.5, 95.0, 95.5, 96.0, 96.5, 97.0, 97.5, 98.0, 98.5, 99.0, 99.1, 99.2, 99.3, 99.4, 99.5, 99.55, 99.60, 99.65, 99.70, 99.75, 99.80, 99.85, 99.90, 99.95, and 100.0.

So, for example, in one embodiment, the substantially inert gas could comprise nitrogen in the concentration range of 92.0-95.0%. In another embodiment, it could be 99.5 and 99.9%. The concentration could also be 99.95%.

### II. D. Polymeric Film

The polymeric film is a single-layer or a multi-layer laminate. One or more polymeric films form each wall of the flexible bag. If there are more than one polymeric films in each wall, they form cavities between two polymeric films. These cavities can be filled with substantially inert gas. The polymeric films comprise preferably of polyethylene (PE). Exemplary polymeric layer comprises low density polyethylene (LDPE), linear low-density polyethylene (LLDPE), and/or LLDPE copolymers. These polymers are described infra.

An exemplary polymeric film comprises low density polyethylene (LDPE), linear low-density polyethylene (LLDPE), and/or LLDPE copolymers.

### II. D. 1. LDPE

By LDPE is meant the low-density polyethylene. Generally, “low-density” refers to the 0.918-0.930 g/cm³ range of polyethylene densities. The LDPE molecules have complex branching patterns, with no easily distinguishable backbone. The polymer molecules are composed of a whole network of branches of various lengths from short to long. The LDPE can be the high-pressure, low-density polyethylene, or HP-LDPE, which is relatively high in average molecular weight, in other words, low in melt-index (0.1-1.1 dg/min).

In one embodiment, the LDPE can be added at up to 30% by weight of the polymer blend of the polymeric film. Stated differently, the weight percent of LDPE in the polymer blend of the polymeric film can be any one of the following numbers measured in %, or in a range defined by any two numbers provided below, including the endpoints of such range: 0; 1; 2; 3; 4; 5; 6; 7; 8; 9; 10; 11; 12; 13; 14; 15; 16; 17; 18; 19; 20; 21; 22; 23; 24; 25; 26; 27; 28; 29; and 30%.

A preferred range of LDPE weight content is from 10-15% of the polymer blend in the polymeric film. A preferred LDPE is one with an MI between 0.25-1 dg/min and a density of 0.918-0.925 g/cm³. For example, Dow 611A, with a density of 0.924 g/cm³ and an MI of 0.88 is preferred. Also preferred is Dow 132i with an MI of 0.25 and a density of 0.921 g/cm³.

### II. D. 2. Ethylene-α-Olefin Copolymer (FAO Copolymer)

The EAO copolymer used herein is ethylene-C₄ to C₁₀-α-olefin interpolymer. The ethylene-Ca to C₁₀-α-olefin interpolymer or EAO copolymer has a melt index of from 0.4 to 1.5 dg/min (dg/min; 190° C., 2.16 kg); a density of from 0.900 to 0.916 g/cm³ may be a single polymer, or a blend of two polymers, or even several individual polymer grades. Interpolymer encompasses copolymers, terpolymers, and the like.

This EAO copolymer may be selected from linear, low-density polyethylenes (LLDPEs). Using industry convention, linear, low-density polyethylenes in the density range 0.915-0.930 g/cm³ will be referred to as LLDPEs and in the density range of 0.900-0.915 g/cm³ will be referred to as ultra-low-density polyethylenes (ULDPEs) or very low-density polyethylenes (VLDPEs).

Heterogeneously branched ULDPE and LLDPE are well-known among practitioners of the linear polyethylene art. They are prepared using Ziegler-Natta solution, slurry or gas phase polymerization processes and coordination metal catalysts as described, for example, by Anderson, et al. in U.S. Pat. No. 4,076,698, the disclosure of which is incorporated herein by reference. These Ziegler-type linear polyethylenes are not homogeneously branched and they do not have any long-chain branching. At a density less than 0.90 g/cm³, these materials are very difficult to prepare using conventional Ziegler-Natta catalysis and are also very difficult to pelletize. The pellets are tacky and tend to clump together. Companies such as Dow, Nova, and Huntsman can produce suitable interpolymers commercially (tradenames Dowlex™, Sclair™ and Rexell™, respectively) using a solution phase process; ExxonMobil, ChevronPhillips and Nova can produce suitable interpolymers (tradenames NTX™, MarFlex™ LLDPE, Novapol™ LLDPE respectively) by a gas phase process; ChevronPhillips uses a slurry process (MarFlex™ LLDPE). These polymers can be used as a blend component of the inner-ply film layer.

Homogeneously branched ULDPEs and LLDPEs are also well known among practitioners of the linear polyethylene art. See, for example, Elston's U.S. Pat. No. 3,645,992. They can be prepared in solution, slurry or gas phase processes using single site catalyst systems. For example, Ewen, et al., in U.S. Pat. No. 4,937,299, describe a method of preparation using a metallocene version of a single site catalyst. The disclosures of Elston and Ewen are incorporated herein by reference. These polymers are sold commercially by ExxonMobil Chemical under the trademark Exact® and by Dow Chemical under the trademark Affinity® and by Nova Chemical under the trademark Surpass®.

The term “homogeneously-branched” is defined herein to mean that (1) the α-olefin monomer is randomly distributed within a given molecule, (2) substantially all of the interpolymer molecules have the same ethylene- to α-olefin monomer ratio, and (3) the interpolymer has a narrow short chain branching distribution. The short chain branching distribution index (SCBDI) is defined as the weight percent of the polymer molecules having a comonomer content within 50 percent of the median total molar comonomer content. The short chain branching distribution index of polyolefins that are crystallizable from solutions can be determined by well-known temperature rising elution fractionation techniques, such as those described by Wild, et al., Journal of Polymer Science, Poly. Phys. Ed., Vol. 20, p. 441 (1982), L. D. Cady, “The Role of Comonomer Type and Distribution in LLDPE Product Performance,” SPE Regional Technical Conference, Quaker Square Hilton, Akron, Ohio, October 1-2, pp. 107-119 (1985), or U.S. Pat. No. 4,798,081.

Suitable C₄ to C₁₀-α-olefin for inclusion in the linear low-density polyethylenes of the present invention may be 1-octene, 1-hexene, 1-butene, or mixtures thereof, most preferably the α-olefin is 1-octene.

A preferred EAO copolymer is up to 40% butene-LLDPE polymer in the density range of from about 0.818 to about 0.922 g/cm³.

As described above, LLDPE copolymers include LLDPE copolymerized with any one or more of butene, hexene and octene, metallocene LLDPE (mPE) or metallocene plastomers, metallocene elastomers, high density polyethylene (HDPE), rubber modified LDPE, rubber modified LLDPE, acid copolymers, polystyrene, cyclic polyolefins, ethylene vinyl acetate (EVA), ethylene acrylic acid (EAA), ionomers, terpolymers, Barex, polypropylene, bimodal resins, any of which may be from either homopolymers or copolymers, and blends, combinations, laminates, micro-layered, nanolayered, and coextrusion thereof. Polyolefins could be manufactured using Ziegler-Natta catalysts, chromium catalysts, metallocene-based catalysts, single-site catalysts and other types of catalysts. The materials listed could be bio-based, petro-based and recycled/reground.

There is extensive description in the art of the types of polymers, interpolymers, copolymers, terpolymers, etc. that may be used in the polymeric film of the flexible bag of the present invention. Examples of patents that describe such polymers include U.S. Pat. Nos. 4,503,102; 4,521,437; and 5,288,531. These patents describe films used to make pouches, which films may also be used to make bags. Other patent references that describe skin layer polymers include U.S. Pat. Nos. 8,211,533; 8,252,397; 8,563,102; 9,757,926; 9,283,736; and 8,978,346.

The thickness of the polymeric film is in the range of 25 μm to 100 μm. Stated differently, the thickness of the sealant layer can be any number from the following number in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the polymeric film can be in the range defined by any two numbers selected from the numbers delineated above, including the end-points of such range.

### III. Flexible Bag Construction

The wall of said flexible bag made from a laminate of flexible materials. In one embodiment, the laminate includes: (A) an FCR-improving layer; (B) an OTR-reducing barrier layer; and (C) a sealant layer.

### III. A. Sealant Layer

As used herein, the term “sealant layer” refers to a layer of a laminate of flexible material, wherein the sealant layer is a material that is configured to be sealed to itself or another sealable layer using any kind of sealing method known in the art, including, for example, heat sealing (e.g. conductive sealing, impulse sealing, ultrasonic sealing, etc.), welding, crimping, bonding, and the like, and combinations of any of these.

Exemplary sealant layer comprises low density polyethylene (LDPE), linear low-density polyethylene (LLDPE), and/or LLDPE copolymers.

The sealant layer comprises LDPE. More specifically, the sealant layer comprises LLDPE.

### III. A. 1. LDPE

By LDPE is meant the low-density polyethylene. Generally, “low-density” refers to the 0.918-0.930 g/cm³ range of polyethylene densities. The LDPE molecules have complex branching patterns, with no easily distinguishable backbone. The polymer molecules are composed of a whole network of branches of various lengths from short to long. The LDPE can be the high-pressure, low-density polyethylene, or HP-LDPE, which is relatively high in average molecular weight, in other words, low in melt-index (0.1-1.1 dg/min).

In one embodiment, the LDPE can be added at up to 30% by weight of the polymer blend of the sealant. Stated differently, the weight percent of LDPE in the polymer blend of the sealant layer can be any one of the following numbers measured in %, or in a range defined by any two numbers provided below, including the endpoints of such range: 0; 1; 2; 3; 4; 5; 6; 7; 8; 9; 10; 11; 12; 13; 14; 15; 16; 17; 18; 19; 20; 21; 22; 23; 24; 25; 26; 27; 28; 29; and 30%.

A preferred range of LDPE weight content is from 10-15% of the polymer blend in the sealant layer. A preferred LDPE is one with an MI between 0.25-1 dg/min and a density of 0.918-0.925 g/cm³. For example, Dow 611A, with a density of 0.924 g/cm³ and an MI of 0.88 is preferred. Also preferred is Dow 132i with an MI of 0.25 and a density of 0.921 g/cm³.

### III. A. 2. Ethylene-α-Olefin Copolymer (EAO Copolymer)

The EAO copolymer used herein is ethylene-C₄ to C₁₀-α-olefin interpolymer. The ethylene-C₄ to C₁₀-α-olefin interpolymer or EAO copolymer has a melt index of from 0.4 to 1.5 dg/min (g/10 min; 190° C., 2.16 kg); a density of from 0.900 to 0.916 g/cm³ may be a single polymer, or a blend of two polymers, or even several individual polymer grades. Interpolymer encompasses copolymers, terpolymers, and the like.

This EAO copolymer may be selected from linear, low-density polyethylenes (LLDPEs). Using industry convention, linear, low-density polyethylenes in the density range 0.915-0.930 g/cm³ will be referred to as LLDPEs and in the density range of 0.900-0.915 g/cm³ will be referred to as ultra-low-density polyethylenes (ULDPEs) or very low-density polyethylenes (VLDPEs).

Heterogeneously branched ULDPE and LLDPE are well-known among practitioners of the linear polyethylene art. They are prepared using Ziegler-Natta solution, slurry or gas phase polymerization processes and coordination metal catalysts as described, for example, by Anderson, et al. in U.S. Pat. No. 4,076,698, the disclosure of which is incorporated herein by reference. These Ziegler-type linear polyethylenes are not homogeneously branched and they do not have any long-chain branching. At a density less than 0.90 g/cm³, these materials are very difficult to prepare using conventional Ziegler-Natta catalysis and are also very difficult to pelletize. The pellets are tacky and tend to clump together. Companies such as Dow, Nova, and Huntsman can produce suitable interpolymers commercially (tradenames Dowlex™, Sclair™ and Rexell™, respectively) using a solution phase process; ExxonMobil, ChevronPhillips and Nova can produce suitable interpolymers (tradenames NTX™, MarFlex™ LLDPE, Novapol™ LLDPE respectively) by a gas phase process; ChevronPhillips uses a slurry process (MarFlex™ LLDPE). These polymers can be used as a blend component of the inner-ply film layer.

Homogeneously branched ULDPEs and LLDPEs are also well known among practitioners of the linear polyethylene art. See, for example, Elston's U.S. Pat. No. 3,645,992. They can be prepared in solution, slurry or gas phase processes using single site catalyst systems. For example, Ewen, et al., in U.S. Pat. No. 4,937,299, describe a method of preparation using a metallocene version of a single site catalyst. The disclosures of Elston and Ewen are incorporated herein by reference. These polymers are sold commercially by ExxonMobil Chemical under the trademark Exact® and by Dow Chemical under the trademark Affinity® and by Nova Chemical under the trademark Surpass®.

The term “homogeneously-branched” is defined herein to mean that (1) the α-olefin monomer is randomly distributed within a given molecule, (2) substantially all of the interpolymer molecules have the same ethylene- to α-olefin monomer ratio, and (3) the interpolymer has a narrow short chain branching distribution. The short chain branching distribution index (SCBDI) is defined as the weight percent of the polymer molecules having a comonomer content within 50 percent of the median total molar comonomer content. The short chain branching distribution index of polyolefins that are crystallizable from solutions can be determined by well-known temperature rising elution fractionation techniques, such as those described by Wild, et al., Journal of Polymer Science, Poly. Phys. Ed., Vol. 20, p. 441 (1982), L. D. Cady, “The Role of Comonomer Type and Distribution in LLDPE Product Performance,” SPE Regional Technical Conference, Quaker Square Hilton, Akron, Ohio, October 1-2, pp. 107-119 (1985), or U.S. Pat. No. 4,798,081.

Suitable C₄ to C₁₀-α-olefin for inclusion in the linear low-density polyethylenes of the present invention may be 1-octene, 1-hexene, 1-butene, or mixtures thereof, most preferably the α-olefin is 1-octene.

A preferred EAO copolymer is up to 40% butene-LLDPE polymer in the density range of from about 0.818 to about 0.922 g/cm³.

As described above, LLDPE copolymers include LLDPE copolymerized with any one or more of butene, hexene and octene, metallocene LLDPE (mPE) or metallocene plastomers, metallocene elastomers, high density polyethylene (HDPE), rubber modified LDPE, rubber modified LLDPE, acid copolymers, polystyrene, cyclic polyolefins, ethylene vinyl acetate (EVA), ethylene acrylic acid (EAA), ionomers, terpolymers, Barex, polypropylene, bimodal resins, any of which may be from either homopolymers or copolymers, and blends, combinations, laminates, micro-layered, nanolayered, and coextrusion thereof. Polyolefins could be manufactured using Ziegler-Natta catalysts, chromium catalysts, metallocene-based catalysts, single-site catalysts and other types of catalysts. The materials listed could be bio-based, petro-based and recycled/reground.

There is extensive description in the art of the types of polymers, interpolymers, copolymers, terpolymers, etc. that may be used in the sealant layer of the flexible bag of the present invention. Examples of patents that describe such polymers include U.S. Pat. Nos. 4,503,102; 4,521,437; and 5,288,531. These patents describe films used to make pouches, which films may also be used to make bags. Other patent references that describe skin layer polymers include U.S. Pat. Nos. 8,211,533; 8,252,397; 8,563,102; 9,757,926; 9,283,736; and 8,978,346.

In one specific embodiment, the present invention provides a sealant film for use in a film structure for containing flowable materials, the sealant film comprising:
(1) from about 2.0 to about 9.5 wt. %, based on 100 wt. % total composition, of an ethylene C4-C10-alpha-olefin interpolymer having a density of from 0.850 to 0.890 g/cc and a melt index of 0.3 to 5 dg/min, the interpolymer being present in an amount such that the film structure develops 10 or less pinholes per 300 cm2 in 20,000 cycles of Gelbo Flex testing, as measured using a Gelbo Flex tester set up to test in accordance with ASTM F392, and has a thermal resistance at temperatures just above 100 C, as measured using DSC (ASTM E794/E793) Differential Scanning calorimetry (DSC) which determines temperature and heat flow associated with material transitions as a function of time and temperature, and a minimum tensile modulus of 20,000 psi as measured using Tensile Modulus of the polyethylene films measured in accordance with ASTM Method D882;
(2) from about 70.5 wt. % to about 98.0 wt. %, based on 100 wt. % total composition, of one or more polymers selected from ethylene homopolymers and ethylene C4-C10-alpha-olefin interpolymers, having a density between 0.915 g/cc and 0.935 g/cc and a melt index of 0.2 to 2 dg/min;
(3) from about 0 wt. % to about 20.0 wt. %, based on 100 wt. % total composition, of processing additives selected from slip agents, anti-block agents, colorants and processing aids; and the sealant film has a thickness of from about 5 to about 60 μm.

In one preferred embodiment, the outer layer of the multi-layer ply comprises ethylene-vinyl alcohol coextrusion; the middle layer comprises metallized biaxial nylon; and the sealant layer comprises LLDPE.

The thickness of the sealant layer is in the range of from about 25 μm to about 100 μm. Stated differently, the thickness of the sealant layer can be any number from the following number in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the sealant layer can be in the range defined by any two numbers selected from the numbers delineated above, including the end-points of such range.

In one embodiment, a polymeric film comprises the following layers: (A) an FCR-improving layer; (B) an OTR-reducing barrier layer; and (C) a sealant layer.

Generally, the sealant layer is on the outside and further away from the product to be packaged in the flexible bag. The FCR-improving layer is on the inside and proximate to the ingredient to be packaged in the flexible bag. The OTR-reducing barrier layer is in between the sealant layer and the FCR-improving layer. Other polymeric layers with other functionalities may be interposed in between the FCR-improving layer and the OTR-reducing barrier layer, and/or in between the OTR-reducing layer and the sealant layer.

The resin composition can form one or more layers of a multilayer coextruded film made in a blowing or casting process. Films of the resin composition can also be combined with other layers in processes such as adhesive lamination, thermal lamination, extrusion lamination, extrusion coating and the like.

### III. B. FCR-Improving Layer

In one embodiment, this layer comprises coextruded EVOH (EVOH co-ex) blown film. EVOH coex holds its oxygen barrier properties (OTR) very well when subjected to flex cracking, or continuous bending. However, co-ex EVOH does not perform well as an oxygen barrier during varying levels of humidity. Flex-cracking would typically occur during the bag manufacture process and can also be experienced during transportation of the filled bags.

The EVOH co-ex comprises 3, 5, 7, 9, 0r 12 layers or even an asymmetric distribution of co-extruded layers.

An example of EVOH coextrusion is a ply or layer comprising polyethylene/tie layer/ethylene vinyl alcohol/tie layer/polyethylene.

Ethylene vinyl alcohol (EVOH) is an extrudable resin that has excellent oxygen, flavor, and aroma barrier properties. EVOH resins and packaging materials have been used for several decades as meat and cheese film wrappers and the barrier properties of EVOH with respect to oxygen, grease, oil, flavor additives, and aroma is well understood.

However, when exposed to humidity levels of 85% or higher, the barrier properties of EVOH degrade. To avoid the degradation, the EVOH is typically extruded in a multi-layer symmetrical coextrusion in which specialized tie resins are used to adhere the EVOH to outer polyolefin layers that protect the EVOH from humidity. For example, in the present invention, a three resin, five-layer coextrusion of EVOH may include LDPE-Tie layer-EVOH-Tie layer-LDPE. In this five-layer structure, the LDPE (low density polyethylene) layers protect the EVOH layer from exposure to moisture. Also, the LDPE and tie-layer are extruded each from one extruder where they are split into two layers and directed to either side of the EVOH layer by a feed-block device. The LDPE and Tie layer are the same material on both sides of the EVOH, thus it is called a symmetrical coextrusion. But even with the multilayer construction, under high relative humidity, for example 90% or 95% or greater, EVOH degrades.

The thickness of the FCR layer is in the range of from about 25 am to about 100 am. Stated differently, the thickness of the FCR layer can be any number from the following number in am: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the FCR layer can be in the range defined by any two numbers selected from the numbers delineated above, including the end-points of such range.

### III. C. OTR-Reducing Barrier Layer

The polymeric materials contemplated as the OTR-reducing barrier layer include any polymeric film oriented or unoriented which includes polymeric or copolymeric PET or PA. PET is polyethylene terephthalate and PA is polyamide or Nylon. The polymeric film is metallized, for example, metallized, PET or metallized PA.

In some embodiments, such films are made from polypropylene or PLA (polylactic acid) or PVOH.

In one embodiment, this layer comprises metallized polyester (Met-PET) or metallized bi-axially oriented polyamide layer (Met-BoPA). Depending on the grades chosen, one can get very good barrier that is not affected by changes in relative humidity. However, the oxygen barrier properties do not stand up very well to flex cracking. By combining both the EVOH for its great flex durability and Met-PET or Met-BoPA, for their resistance against varying relative humidity, one can capitalize on both benefits and create a barrier film that allows for the oxygen barrier properties to be affected minimally during normal application.

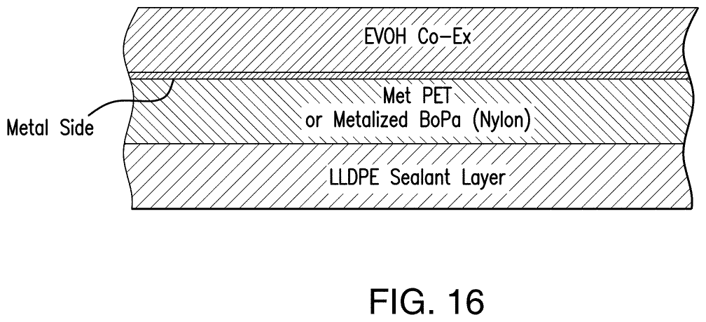

During high and varying relative humidity, the oxygen barrier properties of the EVOH co-ex may be compromised. Traces of oxygen will pass through the EVOH co-ex, but will “bounce off” the metallized layer on the PET or BoPA. The metallized layer will act as the OTR barrier in this high relative-humidity application. This is depicted, for example, in FIG. 16.

During high levels of flex cracking, the metallized layer could be compromised and the EVOH coex protects the construction from oxygen ingress.

By engineering a laminated structure that is not affected by relative humidity, one can control and closely predict the amount of oxygen that passes through the packaging material.

The thickness of the OTR layer is in the range of 25 am to 100 am. Stated differently, the thickness of the OTR layer can be any number from the following number in am: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the OTR layer can be in the range defined by any two numbers selected from the numbers delineated above, including the end-points of such range.

### III. D. Other Ingredients

The present blends may include additional ingredients as processing aids, anti-oxidation agents, UV light stabilizers, pigments, fillers, compatibilizers or coupling agents and other additives that do not affect the essential features of the invention. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

Alternatives to any of these commercially available products would be selectable by a person skilled in the art for the present purposes. The resin blend defined above is selected to ensure that the resulting film has the characteristics defined. Other components, as subsequently described may be added to the blend so long as they do not negatively impact on the desired characteristics of the film of the invention.

### IV. Process for Preparing Flexible-Bags

In one embodiment, the process of the present invention effectively removes all gases that form or accumulate within the different layers of a flexible-bag and replaces it with inert gas, preferably nitrogen, effectively “flushing” the bag during the manufacturing process and sealing the nitrogen inside the flexible-bag cavities.

This additional step eliminates the air comprising of oxygen accumulated in the cavities of a multilayered bag. The nitrogen replacement is performed during the continuous bag-making process, and prior to the filling of the bags with a product, for example, wine. The inert gas is introduced in between the different layers that make up the flexible bag, at the same time as the bag is being manufactured.

In one embodiment, the inert gas such as nitrogen is introduced just before the side seal and/or long seal formation in the flexible-bag-in-box manufacturing line. The side seal/long seal unit effectively makes a tube that acts like a vessel. In the process of the present invention, the tube or the vessel is introduced with inert gas, for example, under pressure that displaces the air including the oxygen in the air. Oxygen is detrimental to the packaged product. The process of the present invention also removes all the air trapped in between the different layers that make up the bag, forcing it out of the only open cavity which is the open end of the tube.

In one embodiment, a sweep or brush pushing down on a plate or roller, trapping the different film layers making the bag, is then used to drive out any residual nitrogen, or any inert gas from the bag before the cross seal/final seal of the bag is made. The final product is a flexible-bag that has inert gas such as nitrogen occupying the open cavities between the film layers and not air comprising oxygen.

### IV. A. Process for Making a Three-Cavity Bag

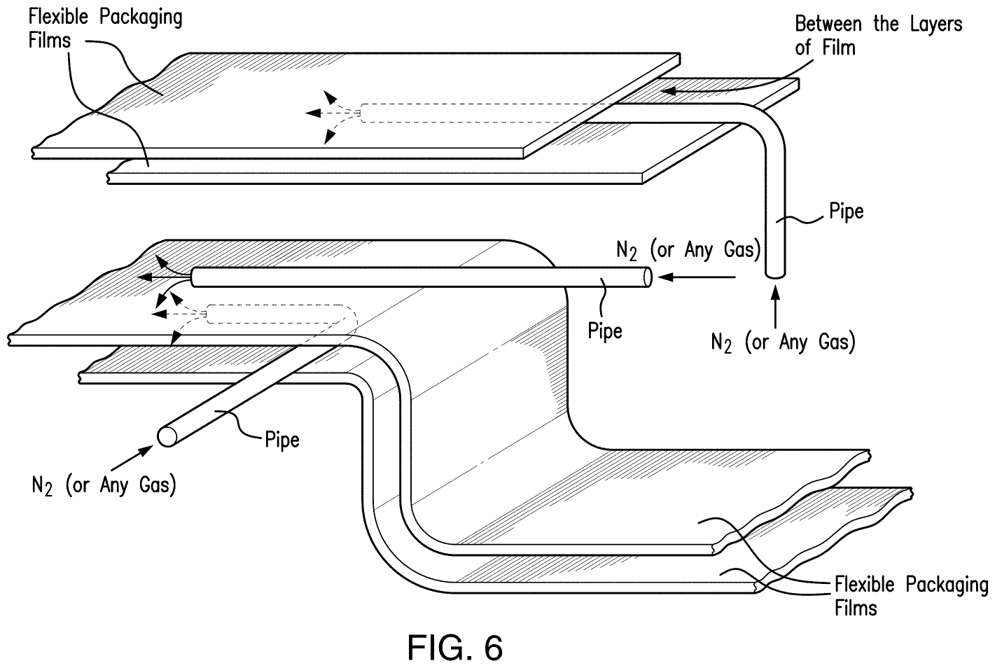

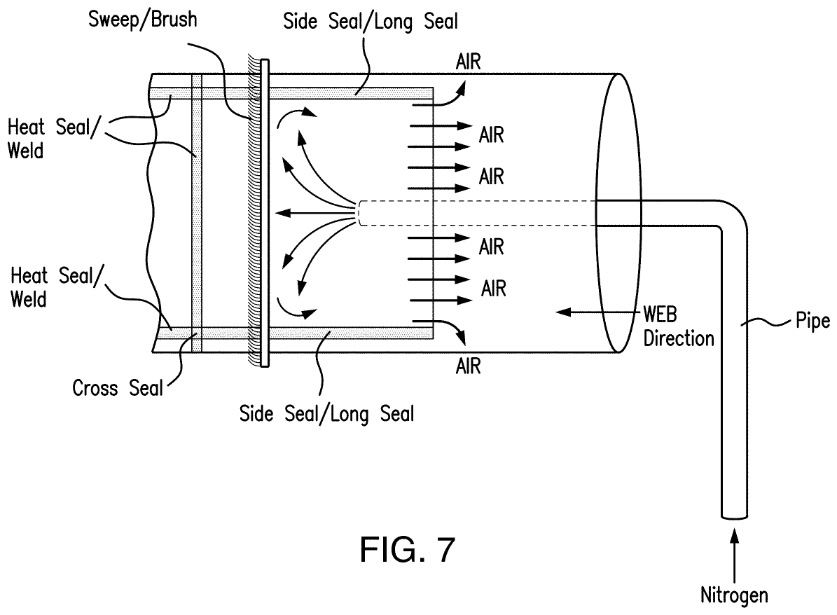

FIGS. 6 and 7 show a process for preparing a flexible bag, comprising the steps of introducing an inert gas such as nitrogen in the first cavity of the three cavity bag through a first main-tube connected to an external gas source; introducing the inert gas through a second main-tube into the second cavity; and introducing the inert gas into the third cavity through a third main-tube; from an external gas source during the continuous process of flexible bag-making. The inert gas replaces, substantially, all air in the three cavities with the inert gas. The three cavities are sealed at the edges or the perimeter, which is followed by a sweeping or burping to remove as much air/nitrogen in between the cavities as possible. These steps are repeated for preparing the next flexible bag in the continuous or even a stop-and-start process of flexible-bag-making

The introduction of inert gas such as nitrogen does not consume time that slows down the bagmaking speed in any significant fashion, if at all.

In one embodiment, the gas introduced from the external gas source comprises nitrogen, argon, helium, or a combination thereof. In one embodiment, the inert gas is essentially nitrogen.

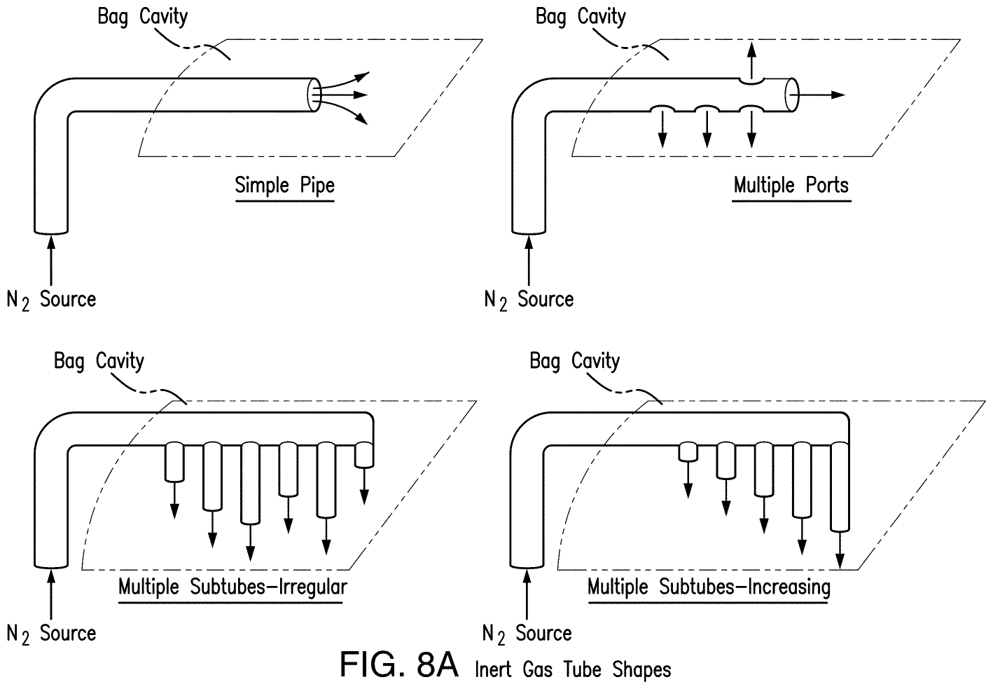

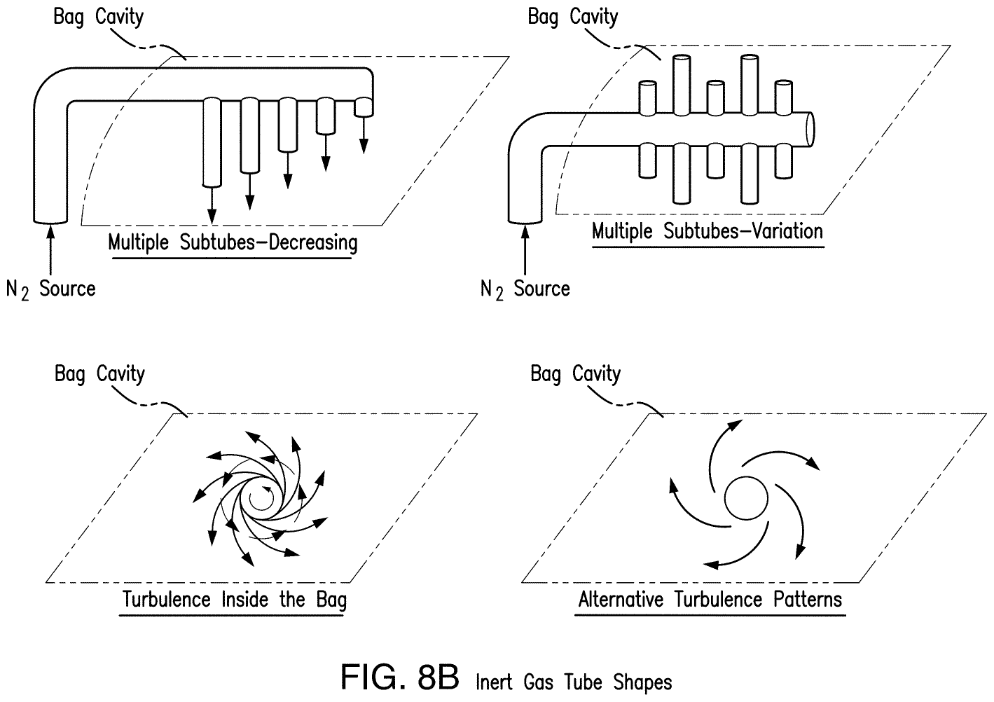

In one embodiment, the main tube introducing air into the cavities is a simple tube. In another embodiment, the main tube comprises multiple inlet ports. In another embodiment, the multiple inlet ports are located at the ends of multiple sub-tubes emanating from said at least one main tube, and wherein said multiple sub-tubes are of various lengths. In another embodiment, the multiple-sub-tubes are organized in a gradually-increasing-in-length or a gradually-decreasing-in-length fashion. In yet another embodiment, the inert gas is introduced into the cavities is in a turbulent flow. In a further embodiment, the turbulent flow creates a circular flow of the inert gas that displaces the air in one or more cavities. This turbulent flow is created as a result of high pressure of inert gas or as a result of differential pressure due to different lengths of sub-tubes introducing the inert gas into the cavities. This invention also covers the embodiment where one, two, or all three cavities have the air replaced by inert gas such as nitrogen. This invention also covers the embodiment wherein one or two or all three cavities have circular flow created by turbulent flow. FIG. 8 shows the various embodiments of the invention described above.

The three-cavity bag is described above. The same process applies for a multiple cavity bag, which has higher number of polymeric films that form cavities between two such films. The same process can apply to the single-cavity flexible bag, where the only cavity in which the product such as wine will be eventually packaged, has the air inside replaced with inert gas such as nitrogen. The previous embodiments described in context of the threecavity flexible bags apply to the multiple-cavity bag and the single-cavity bag.

In some aspects, the invention provides an improved bag-making process comprising the steps of providing a multi-ply film structure, having inner and outer plies, wherein at least one of the plies is a film of the invention, securing a spout to inner and outer plies of the film structure through a hole provided therein, sealing the plies together transversely across the width of the multi-ply film structure, to form a top seal of one bag and a bottom seal of the bag and a top seal of an adjacent bag, then sealing the plies together parallel to the length of the bag line are applied at either side of the films, and trapped air being removed prior to completely sealing the bag, and separating the bags immediately or just prior to use.

In one embodiment, the F-S-F machine is used for making the flexible bags. In this machine, the bag is formed and sealed. Then it is filled with product later, and not continuously during formation. In the first step, one, two, or another suitable number of reels of film unwind. A hole is cut in the top layer and a spout and tap assembly (fitment) is positioned and sealed. The perimeter of the bag is sealed. The finished bag is cut and separated. The bag is optionally transferred to a rotary filler. Then the bag is filled and loaded into a carton. Alternatively, sealed and closed (fitment) bags are supplied to the filler who fills the flexible bags with food product such as wine. The F-S-F machine is from the Flextainer Co. In the F-S-F model, the film and the fitments ae supplied to the customers' filling centers.

Bag-making process is described generally in U.S. Pat. No. 8,211,533, which is incorporated by reference herein.

In one aspect, the present invention relates to providing a film described herein for making a bulkbag, wherein said film forms the inner-ply of the multi-ply bag.

V. Bags Filled with Flowable Materials

In one aspect, this invention also relates to bags described above, filled with flowable materials. Examples include bags filled with flowable materials such as water, beverages, juices, coffee, tea, energy drinks, beer, wine, sauces, mustard, ketchup, food dressings, milk, cheese, sour-cream, mayonnaise, salad dressings, relish, oils, soft margarine, coffee concentrate, pastes, puree, ice cream mix, milk shake mix, preserves, emulsions, doughnut fillings, jellies, detergents, caulking materials, medicines, materials used in manufacturing, and the like.

### V. A. Polymeric Films—Various Embodiments

### V. A. 1. Embodiment 1 Thermal Lamination (Hot Roll) Process

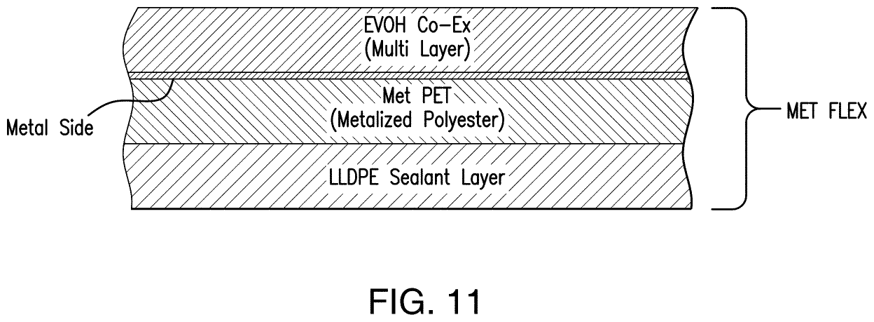

In one embodiment, the invention film comprises 3 layers of flexible film: LLDPE sealant layer; metallized polyester (met-PET) OTR-reducing barrier layer; and FCR-improving co-extruded EVOH layer. These layers are thermally laminated together to form 1 structure used in the flexible packaging applications. The selection of the raw materials and the placement in their specific order, add value to the material achieving great results in flex-cracking subjected during transportation, and oxygen transmission rate when exposed to high levels of humidity. As shown in FIG. 11, in this embodiment, the Met-Flex construction is manufactured using the Thermal lamination, (Hot Roll) process. Typical characteristics are:

First Layer: EVOH Coextruded Blown Film
Layer construction: 3, 5, 7, 9, 12; multi-stream using multiplication layer distribution.
Total thickness is 25-100 micron.

Second Layer: Met-PET
10-15 micron metallized polyester.
Total thickness is 25-100 micron.

Third Layer: LLDPE—Sealant layer
Total thickness is 25-100 micron.

### V. A. 2. Embodiment 2—Extrusion Lamination/Coating

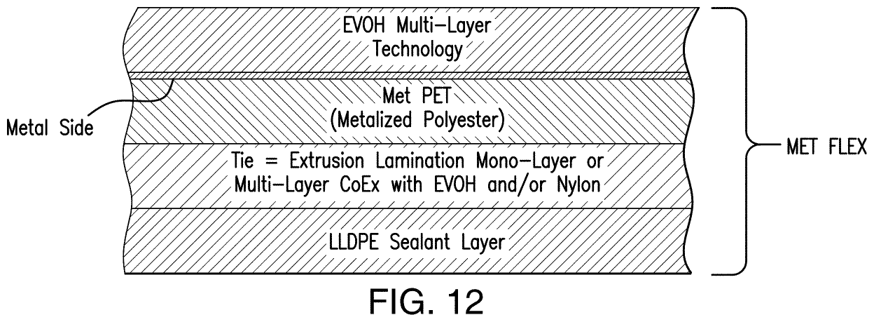

In one embodiment, the invention film comprises 4 layers of flexible film: LLDPE sealant layer; a tie layer; metallized polyester (met-PET) OTR-reducing barrier layer; and FCR-improving co-extruded EVOH layer. These layers are thermally laminated together to form a structure used in the flexible packaging applications. As shown in FIG. 12, in this embodiment, the Met-Flex construction is manufactured using the Extrusion Lamination/Coating process. Typical characteristics are:

First Layer: EVOH Extrusion-Coated Coextruded Blown Film
Layer construction: 3, 5, 7, 9, 12; multi-stream using multiplication layer distribution.
Total thickness is 25-100 micron.

Second Layer: Met-PET
10-15 micron metallized polyester, with an oxygen transmitting rate of 0.05 cm³/m²-day to 3 cm³/m²-day.
Total thickness is 25-100 micron.
Metal side is contacts the EVOH layer.

Third Layer: Tie Layer
The tie-layer is made using extrusion lamination, which is a monolayer or a multilayer co-extrusion with EVOH and/or nylon.

Fourth Layer: LLDPE—Sealant layer
Total thickness is 25-100 micron.

### V. A. 3. Embodiment 3—Extrusion Lamination/Co-Extrusion Multi-Layer Technology

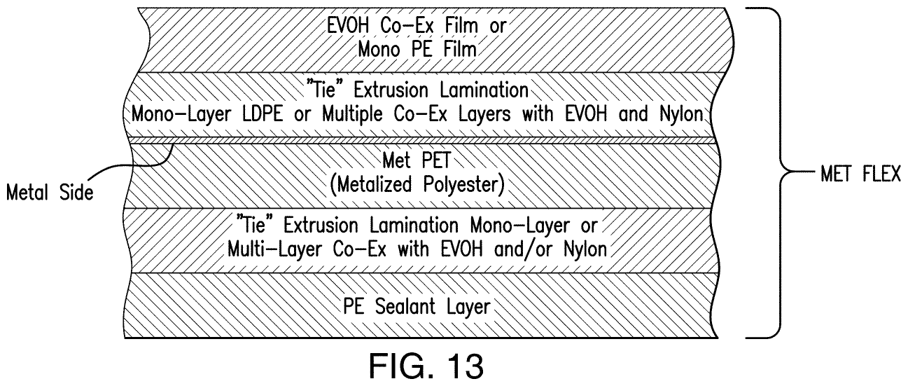

In one embodiment, the invention film comprises 5 layers of flexible film: PE sealant layer; a first tie layer; metallized polyester (met-PET) OTR-reducing barrier layer; a second tie layer; and FCR-improving coextruded EVOH layer. These layers are made by extrusion lamination and multi-layer technology to form a structure used in the flexible packaging applications. As shown in FIG. 13, in this embodiment, the Met-Flex construction is manufactured using the Extrusion Lamination/Co-extrusion Multi-Layer Technology. Typical characteristics are:

First Layer: EVOH Extrusion-Coated Coextruded Blown Film or Monolayer PE Film
Layer construction: 3, 5, 7, 9, 12; multi-stream using multiplication layer distribution.
Total thickness is 25-100 micron.

Second Layer: Tie Layer
The tie-layer is made using extrusion lamination, which is a monolayer LDPE or a multilayer co-extrusion with EVOH and/or nylon.

Third Layer: Met-PET
10-15 micron metallized polyester, with an oxygen transmitting rate of 0.05 cm³/m²-day to 3 cm³/m²-day.
Total thickness is 25-100 micron.
Metal side contacts the tie layer.

Fourth Layer: Tie Layer
The tie-layer is made using extrusion lamination, which is a monolayer LDPE or a multilayer co-extrusion with EVOH and/or nylon.

Fifth Layer: LLDPE—Sealant layer

### V. A. 4. Embodiment 4—Extrusion Lamination/Thermal Hot Roll Process

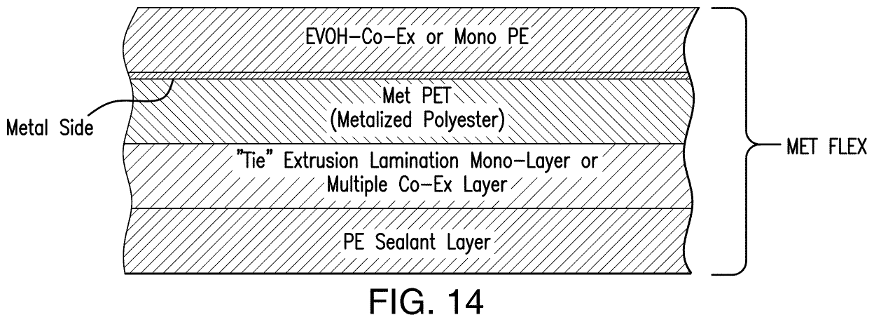

In one embodiment, the invention film comprises 4 layers of flexible film: PE sealant layer; a first tie layer; metallized polyester (met-PET) OTR-reducing barrier layer; a second tie layer; and FCR-improving coextruded EVOH layer. These layers are made by extrusion lamination and multi-layer technology to form a structure used in the flexible packaging applications. As shown in FIG. 14, in this embodiment, the Met-Flex construction is manufactured using the Extrusion Lamination/Hot Roll Thermal Lamination Typical characteristics are:

First Layer: EVOH Extrusion-Coated Coextruded Blown Film or Monolayer PE Film
Layer construction: 3, 5, 7, 9, 12; multi-stream using multiplication layer distribution.
Total thickness is 25-100 micron.

Second Layer: Met-PET
10-15 micron metallized polyester, with an oxygen transmitting rate of 0.05 cm³/m²-day to 3 cm³/m²-day.
Total thickness is 25-100 micron.
Metal side contacts the tie layer.

Third Layer: Tie Layer
The tie-layer is made using extrusion lamination, which is a monolayer LDPE or a multilayer co-extrusion with EVOH and/or nylon.

Fourth Layer: LLDPE—Sealant layer

### V. A. 5. Embodiment 5—Adhesive Lamination

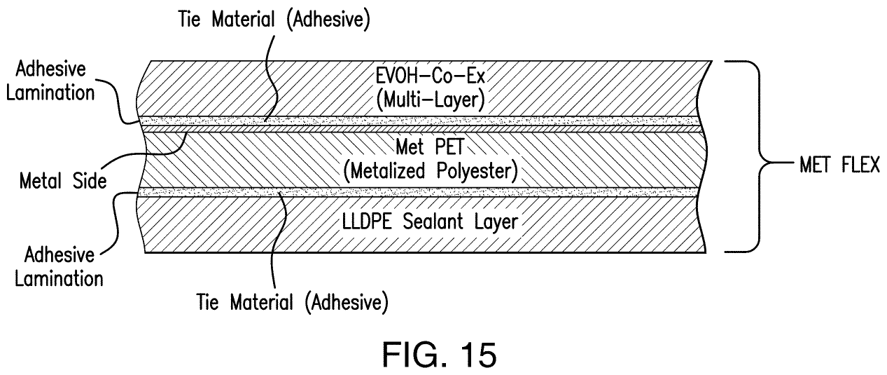

In one embodiment, the invention film comprises 3 layers of flexible film: PE sealant layer; metallized polyester (met-PET) OTR-reducing barrier layer; and FCR-improving co-extruded EVOH layer. These layers are made by adhesive lamination to form a structure used in the flexible packaging applications. As shown in FIG. 15, in this embodiment, the Met-Flex construction is manufactured using the Extrusion Lamination/Hot Roll Thermal Lamination Typical characteristics are:

First Layer: EVOH Extrusion-Coated Coextruded Blown Film or Monolayer PE Film
Layer construction: 3, 5, 7, 9, 12, Multi-stream using multiplication layer distribution.
Total thickness is 25-100 micron.

Second Layer: Met-PET
10-15 micron metallized polyester, with an oxygen transmitting rate of 0.05 cm³/m²-day to 3 cm³/m²-day.
Total thickness is 25-100 micron.
Metal side contacts the tie layer.

Fourth Layer: LLDPE—Sealant Layer

The three layers adhere to each other using a tie material, an adhesive. A layer with an adhesive with solvent and solventless adhesive can be used.

Alternatives to any of these commercially available products would be selectable by a person skilled in the art for the present purposes. The resin blend defined above is selected to ensure that the resulting film has the characteristics defined. Other components, as subsequently described may be added to the blend as long as they do not negatively impact on the desired characteristics of the film of the invention.

### V. B. Other Ingredients

The present blends may include additional ingredients as processing aids, anti-oxidation agents, UV light stabilizers, pigments, fillers, compatibilizers or coupling agents and other additives that do not affect the essential features of the invention. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

### VI. Bulk-Bags

Other aspects of the invention include bags for containing flowable materials made from the above films.

The bags may be irradiated prior to use in accordance with standard procedures well known in the packaging art.

In multi-layer polymeric film, the layers generally adhere to each other over the entire contact surface, either because the polymer layers inherently stick to each other or because an intermediate layer of a suitable adhesive is used. The bags which may be produced from the films of the invention are pre-made and then usually filled with food through a fitment. They are often sterilized and may be, for example, irradiated in a batch process, employing standard radiation conditions known in the art. The film may also be sterilized rather than the bags. Sterilization can be achieved in a variety of known ways such as by exposure of the film or bag to hydrogen peroxide solution. The films used to make pouches may be similarly treated prior to package formation. Of importance is that the films and bags can endure aseptic packaging condition.

The bags or pouches using the resin blend compositions of the present invention can also be surface treated and then printed by using techniques known in the art, e.g., use of corona treatment before printing.

In one embodiment, this invention relates to a flexible bag described herein, wherein said bag has a capacity from about 1 L to 400 gallons. For example, the bags may range in size given by any number given below in gallons, or within the range defined by any two numbers given below, including the end-points: 1, 2, 3, 4, 5, 6, 7, 8, 9, 10, 20, 30, 40, 50, 60, 70, 80, 90, 100, 150, 250, 300, 350, 400.

In some aspects, the capacity of the bags made from the composition of the present invention may be sized from about 100 mL to about 8000 mL. For example, the bags may range in size given by any number given below in milliliters (mL), or within the range defined by any two numbers given below, including the end-points: 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3500, 4000, 4500, 5000, 5500, 6000, 6500, 7000, 7500, 8000.

The bags are pre-made and then usually filled through a fitment. They are often radiation sterilized in a batch process by the bag manufacturer. The packaging conditions may include those for aseptic packaging.

### EXPERIMENTAL

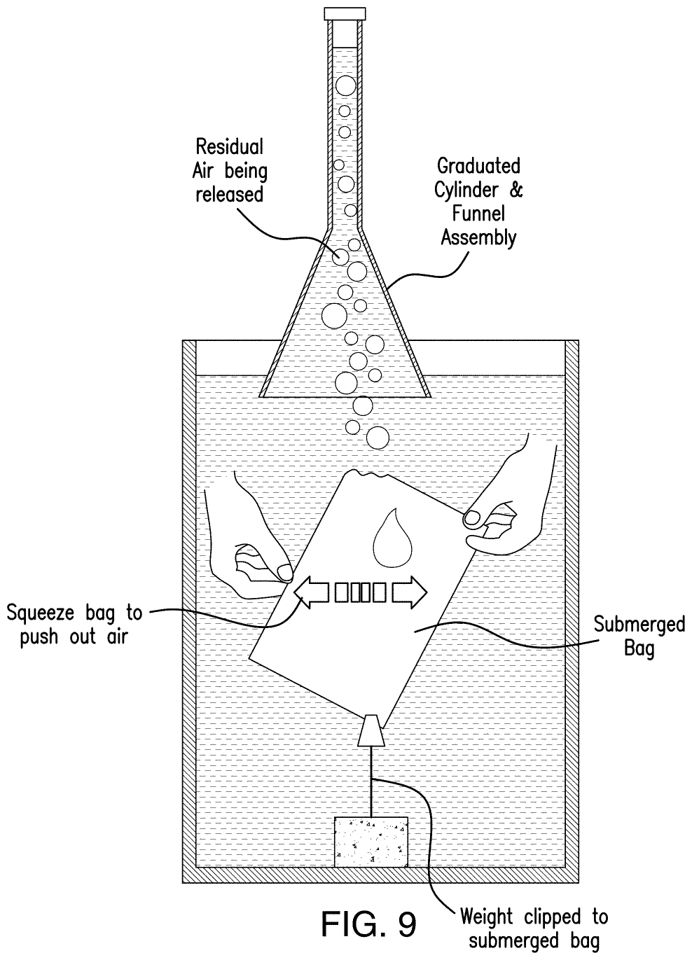

To determine the amount of air trapped in a flexible-bag after manufacture is called the Residual Air Test, which is described below and schematically shown in FIG. 9. A large-sized water-filled container that would fully submerge a bag was provided. Generally, the procedure is used for bags less than 5-gallon filling capacity.

A graduated cylinder with an attached funnel was filled with water fully and was placed inverted in a holder over the water ensuring that no air was present in the cylinder, and that the cylinder was filled only with water. A weight was clipped on to a sample flexible-bag and the bag was submerged into the tank. The weight allowed for the bag to remain submerged in the water.

For measuring the air between the plies, for example, in a multiple-ply bag, first, the fitment cap or the tap was opened and the air was allowed to escape, but without being captured by the graduated cylinder. Then, the bag was held under the cylinder-funnel assembly, and a bag corner was cut with scissors. All air was squeezed out including that in the spout area but within the multiple plies and was captured in the graduated cylinder.

For measuring the total air trapped in the bag, including in the main cavity or chamber, which is for the filling of the packaged product such as wine, the bag was held under the cylinder-funnel assembly, and a bag corner was cut with scissors. All air was squeezed out including that in the spout area and was captured in the graduated cylinder.

The residual air that was trapped within the funnel assembly was subsequently sampled for oxygen content using a Model 905 Headspace Oxygen Analyzer as supplied by Quantek Instruments. The ZERO setting of the 905 analyzer was set by flushing nitrogen until a stable reading near zero was obtained. The oxygen ZERO adjuster on the machine was tuned until a reading of 0.0% oxygen was obtained. Calibration conditions were 72F, 55% RH, and elevation of 507 ft. The SPAN setting of the oxygen channel was set by flushing with compressed air until a stable reading was obtained. The SPAN adjuster was tuned until a reading 20.9% oxygen was obtained.

After the N2 replacement, several three-cavity flexible-bags were analyzed using the 905 analyzer to determine the residual oxygen content in the bags (which were edge sealed and closed). A ten-sample average provided a result of 0.24% oxygen in the main cavity. Stated another way, from a residual air having about 20.47% oxygen, the inert gas replacement now produced bags that have only 0.24% oxygen in all cavities.

TABLE 2
Oxygen Content in %

| | Middle Cavity |
|---|---|
| Sample No. | Oxygen Content % |
| 1. | 0.21 |
| 2. | 0.21 |
| 3. | 0.20 |
| 4. | 0.26 |
| 5. | 0.26 |
| 6. | 0.23 |
| 7. | 0.23 |
| 8. | 0.15 |
| 9. | 0.33 |
| 10 | 0.36 |
| Average | 0.24 |

Headspace inside the cone of the bag was calculated according to the following formula, wherein % O₂ is the percentage of oxygen in the cone:

[(% O₂)×(Volume of Headspace in mL)×(1.429 mg O₂/mL O₂)]/[(Volume of wine in L in the BiB)]

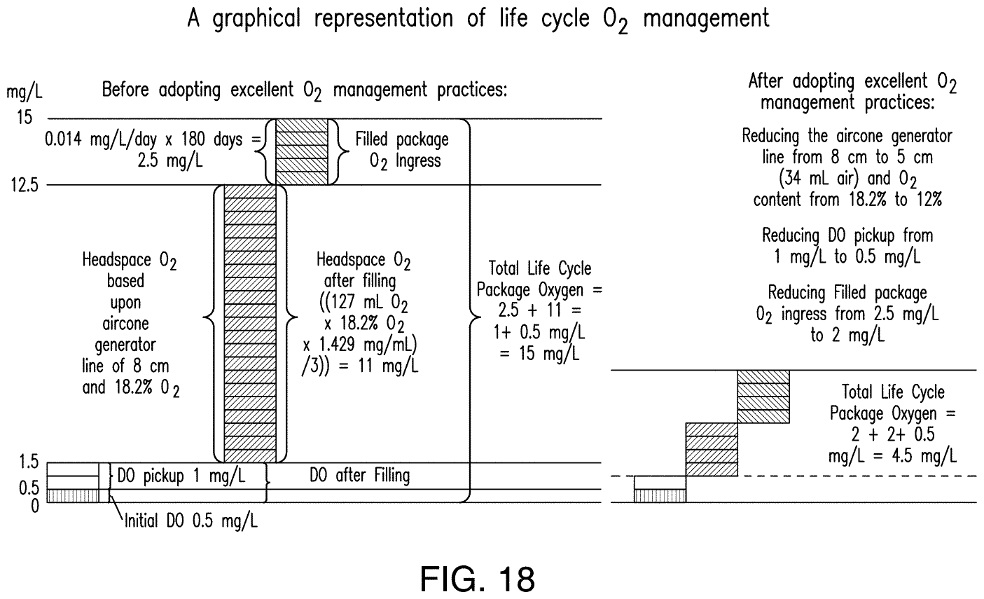

The following tables depict comparisons of head space within the bag between a bag according to the present invention and various bags from competitors. A graphical representation of the life cycle oxygen management can be found, for example, in FIG. 18.

TABLE 3
Bag Test 1—Control Sample

| Oxygen Source | Oxygen Content |
|---|---|
| Initial Oxygen Before Filling | 0.5 mg/L |
| Oxygen Pick-up During Filling of Wine | 1 mg/L |
| Oxygen Transport Through Packaging in 180 Days | 2.5 mg/L |
| Oxygen In Headspace | 3 mg/L |
| Total Lifecycle Oxygen | 7 mg/L |

Bag Test 1 was conducted on a first competitor bag sample in which nitrogen flushing was not performed.

TABLE 4
Bag Test 2—Experimental Sample

| Oxygen Source | Oxygen Content |
|---|---|
| Initial Oxygen Before Filling | 0.5 mg/L |
| Oxygen Pick-up During Filling of Wine | 1 mg/L |
| Oxygen Transport Through Packaging in 180 Days | 2.5 mg/L |
| Oxygen In Headspace | 0.04 mg/L |
| Total Lifecycle Oxygen | 4.04 mg/L |

Bag Test 2 was conducted on an experimental bag sample in which nitrogen flushing was performed with adoption of excellent oxygen management techniques.

TABLE 5
Bag Test 3—Control Sample

| Oxygen Source | Oxygen Content |
|---|---|
| Initial Oxygen Before Filling | 0.5 mg/L |
| Oxygen Pick-up During Filling of Wine | 1 mg/L |
| Oxygen Transport Through Packaging in 180 Days | 2.5 mg/L |
| Oxygen In Headspace | 11 mg/L |
| Total Lifecycle Oxygen | 15 mg/L |

Bag Test 3 was conducted on a second competitor bag sample in which N2 flushing was not performed, wherein the bag was made using a typical bag manufacturing process.

TABLE 6
Bag Test 4—Control Sample

| Oxygen Source | Oxygen Content |
|---|---|
| Initial Oxygen Before Filling | 0.5 mg/L |
| Oxygen Pick-up During Filling of Wine | 1 mg/L |
| Oxygen Transport Through Packaging in 180 Days | 2.5 mg/L |
| Oxygen In Headspace | 1.94 mg/L |
| Total Lifecycle Oxygen | 5.94 mg/L |

Bag Test 4 was conducted on the second competitor bag sample in which N2 flushing was not performed, wherein the bag was made using a very good bag manufacturing process.

TABLE 7
Percent Reduction in Oxygen Content

| | | Comparative Percent |
|---|---|---|
| | | Decrease in Total Life Cycle |
| | Total Life | Oxygen for Experimental |
| Bag Identity | Cycle Oxygen | Sample in Bag 2 |
| Bag 1—Control 1 | 7 mg/L | 42% |
| Bag 2—Experimental | 4.04 mg/L | -NA- |
| Bag 3—Control 2, Typical, | 15 mg/L | 73% |
| Typical Manufacturing | | |
| Bag 4—Control 2, Good | 5.94 mg/L | 32% |
| Manufacturing | | |

Even when compared to the commercial bag made with the best manufacturing technique, the experimental bag showed a decrease in oxygen content of 32%. In comparison with a typically made flexible bag, the experimental bag showed a 73% reduction in total oxygen content in the bag's lifecycle. According to the study conducted by the French National Institute for Agricultural Research in 2004, the Test Bag 2, which incorporates the nitrogen flushing technology of the invention would effectively extend the shelf life by 3 months or more.

What is claimed is:

1. A flexible bag for packaging a product to reduce the impact of oxygen on the product and/or to increase said product's shelf life:
wherein said flexible bag is sealed at the edges that form at least one cavity;
wherein said flexible bag comprises at least one fitment in closed position on one side of said flexible bag for filling it with one of said products;
wherein said flexible bag comprises at least one cavity that comprises a gas;
wherein said gas comprises less than 10% oxygen before filling said flexible bag with one of said products; and
wherein said flexible bag is made from polymeric films.

2. The flexible bag as recited in claim 1, wherein said flexible bag has four sealed edges.

3. The flexible bag as recited in claim 1, wherein said flexible bag has more than one cavity, wherein each such cavity is formed by two or 4 layers of polymeric films.

4. The flexible bag as recited in claim 1, wherein at least 90% of said gas is selected from nitrogen, argon, helium, and a combination thereof.

5. The flexible bag as recited in claim 1, wherein at least 90% of said gas is nitrogen.

6. The flexible bag as recited in claim 1, wherein at least 99% of said gas is nitrogen.

7. The flexible bag as recited in claim 1;
wherein said bag comprises three cavities: a first cavity, a second cavity, and a third cavity;
wherein said first cavity is defined by a first polymeric film layer and a second polymeric film layer;
wherein said second cavity is defined by said second polymeric film layer and a third polymeric film layer; and
wherein said third cavity is defined by said third polymeric film layer and a fourth polymeric film layer;
wherein said first, second, third, and fourth polymeric film layers are coplanar, and sealed at the edges;
wherein said second cavity is central to said first cavity and said third cavity;
wherein said second cavity is used for filling said product;
wherein said second cavity is connected to said fitment for filling and dispensation of said product; and
wherein said three cavities, prior to filling of said product, comprise of said gas.

8. The flexible bag, as recited in claim 7, wherein:
said first polymeric film layer and/or said fourth polymeric film layer comprise metallized PET or metallized BoPA or Clear BoPA;
and optionally, said second polymeric film layer and/or said third polymeric film layer comprises EVOH co-ex or BoPA co-ex, or combination of both.

9. The flexible bag as recited in claim 1;
wherein said bag comprises one cavity;
wherein said cavity is defined by a first polymeric film layer and a second polymeric film layer;
wherein said first and second polymeric film layers are coplanar, and sealed at the edges;
wherein said cavity is used for filling said product;
wherein said cavity is connected to said fitment for filling and dispensation; and
wherein said cavity, prior to filling of said product comprises of said gas.

10. The flexible bag, as recited in claim 9, wherein said first polymeric film layer and said second polymeric film layer comprise the following layers:
(A) a sealant layer, wherein said sealant layer comprises LLDPE; and/or
(B) an OTR-reducing barrier layer, wherein said OTR-reducing barrier layer comprises metallized PET or metallized BoPA; and/or Clear BoPA;
(C) an FCR-improving layer; wherein said FCR-improving layer comprises EVOH coex, or BoPA co-ex, Or combination of both.

11. A process for preparing a flexible bag as recited in claim 1, comprising the steps of:
introducing a portion of said gas through at least one main tube into said at least one cavity from an external gas source during the continuous or stop start process of flexible bagmaking;
replacing, substantially, all air in said at least one cavity with said portion of said gas;
sealing said at least one cavity to trap said gas inside; and
repeating the above steps for the next flexible bag in the continuous or stop start process of flexible bag-making.

12. The process as recited in claim 11, wherein said portion of said gas introduced from an external gas source comprises nitrogen, argon, helium, or a combination thereof.

13. The process as recited in claim 11, wherein said portion of said gas essentially consists of nitrogen.

14. The process as recited in claim 11, wherein said at least one main tube comprises multiple inlet ports for introducing said portion of said gas to replace said air in said at least one cavity of said flexible bag.

15. The process as recited in claims claim 11, wherein said multiple inlet ports are located at the ends of multiple sub-tubes emanating from said at least one main tube, and wherein said multiple sub-tubes are of various lengths.

16. The process as recited in claim 15, wherein said multiple-sub-tubes are organized in a gradually-increasing-in-length or a gradually-decreasing-in-length fashion.

17. The process as recited in claim 11, wherein said portion of said gas introduced in said at least one cavity is in a turbulent flow.

18. The process as recited in claim 11, wherein said turbulent flow creates a circular flow of said portion of said gas that displaces the air in said at least one cavity.

19. A process for preparing a flexible bag as recited in claim 11, comprising the steps of:
introducing a portion of said gas of said first cavity through a first main-tube into said first cavity from an external gas source during the continuous process of flexible bag-making;
introducing a portion of said gas of said second cavity through a second main-tube into said second cavity from an external gas source during the continuous process of flexible bag-making;
introducing a portion of said gas of said third cavity through a third main-tube into said third cavity from an external gas source during the continuous process of flexible bagmaking;
replacing, substantially, all air in said three cavities with said portions of said gases corresponding to each cavity;
sealing said three cavities to trap said gases inside; and optionally sweeping the air out, or burping the pouch to again remove as much air/inert gas as possible;
repeating the above steps for the next flexible bag in the continuous process of flexible bag-making.

20. The process as recited in claim 19, wherein said portions of said gases introduced from an external gas source comprises nitrogen, argon, helium, or a combination thereof.

21. The process as recited in claim 19, wherein said portions of said gases essentially consist of nitrogen.

22. The process as recited in claim 19, wherein at least one of said first, second, and third main-tubes comprises multiple inlet ports for introducing said portions of said gases to replace said air in said three cavities of said flexible bag.

23. The process as recited in claim 19, wherein said multiple inlet ports are located at the ends of multiple sub-tubes emanating from said first, second, and third main-tubes, and wherein said multiple sub-tubes of at least one of the first, second, and the third main-tubes are of various lengths.

24. The process as recited in claim 23, wherein said multiple sub-tubes of at least one of the first, second, and the third main-tubes are organized in a gradually-increasing-in-length and/or a gradually-decreasing-in-length fashion.

25. The process as recited in claim 19, wherein said portions of said gases introduced in said first, second, and/or third cavity, create turbulent flows.

26. The process as recited in claim 19, wherein said turbulent flows create circular flows of said portions of said gases that displace the air in said first, second, and/or third cavity.

27. A process for preparing a flexible bag as recited in claim 9, comprising the steps of:
introducing a portion of said gas through a main-tube into said cavity from an external gas source during the continuous process of flexible bag-making;
replacing, substantially, all air in said cavity with said portion of said gas;
sealing said cavity to trap said gas inside; and
repeating the above steps for the next flexible bag in the continuous process of flexible bag-making.

28. The process as recited in claim 27, wherein said portion of said gas introduced from an external gas source comprises nitrogen, argon, helium, or a combination thereof.

29. The process as recited in claim 27, wherein said portion of said gas essentially consists of nitrogen.

30. The process as recited in claim 27, wherein said main-tube comprises multiple inlet ports for introducing said portion of said gas to replace said air in said cavity of said flexible bag.

31. The process as recited in claim 27, wherein said multiple inlet ports are located at the ends of multiple sub-tubes emanating from said main-tube, and wherein said multiple sub-tubes are of various lengths.

32. The process as recited in claim 27, wherein said multiple sub-tubes of said main-tube are organized in a gradually-increasing-in-length or a gradually-decreasing-in-length fashion.

33. The process as recited in claim 27, wherein said portion of said gas introduced in said cavity creates turbulent flow.

34. The process as recited in claim 27, wherein said turbulent flow creates a circular flow of said portion of said gas that displaces the air in said cavity.

35. A flexible bag comprising a product:
wherein said flexible bag is sealed at the edges that form more than one cavity;
wherein said product is filled in only one cavity of said more than one cavity, the remaining cavities being non-filled cavities;
wherein said flexible bag comprises at least one fitment in closed position on its one side, for dispensing said product from said flexible bag;
wherein said non-filled cavities comprise a gas;
wherein said gas comprises less than 10% oxygen; and
wherein said flexible bag is made from polymeric films.

36. The flexible bag as recited in claim 35, wherein said flexible bag has four sealed edges.

37. The flexible bag as recited in claim 35, wherein said flexible bag has more than one cavity, wherein each such cavity is formed by two layers of polymeric films.

38. The flexible bag as recited in claim 35, wherein at least 90% of said gas is selected from nitrogen, argon, helium, and a combination thereof.

39. The flexible bag as recited in claim 35, wherein at least 90% of said gas is nitrogen.

40. The flexible bag as recited in claim 35, wherein at least 99% of said gas is nitrogen.

41. The flexible bag as recited in claim 35;
wherein said bag comprises three cavities: a first cavity, a second cavity, and a third cavity;
wherein said first cavity is defined by a first polymeric film layer and a second polymeric film layer;
wherein said second cavity is defined by said second polymeric film layer and a third polymeric film layer;
wherein said third cavity is defined by said third polymeric film layer and a fourth polymeric film layer;
wherein said first, second, third, and fourth polymeric film layers are coplanar, and sealed at the edges;
wherein said second cavity is central to said first cavity and said third cavity;
wherein said second cavity is filled said product;
wherein said second cavity is connected to said fitment for dispensation; and
wherein said first and third cavities comprise of said gas.

42. The flexible bag, as recited in claim 41, wherein:
said first polymeric film layer and/or said fourth polymeric film layer comprise metallized PET or metallized BoPA; or BoPA co-ex, Or combination of both;
and optionally, said second polymeric film layer and/or said third polymeric film layer comprises EVOH co-ex, or BoPA co-ex, Or combination of both.

43. The flexible bag as recited in claim 35;
wherein said bag comprises one cavity filled with said product;
wherein said cavity is defined by a first polymeric film layer and a second polymeric film layer;
wherein said first, and second polymeric film layers are coplanar, and sealed at the edges;
wherein said cavity is connected to said fitment for dispensation; and
wherein said cavity, prior to filling of said product comprised of said gas.

44. The flexible bag, as recited in claim 43, wherein said first polymeric film layer and said second polymeric film layer comprise the following layers:
(A) a sealant layer, wherein said sealant layer comprises LLDPE; and/or
(B) an OTR-reducing barrier layer;
(C) an FCR-improving layer; wherein said FCR-improving layer comprises EVOH coex.

45. The flexible bag, as recited in claim 44, wherein said first polymeric film layer and said second polymeric film layer comprise the following layers:
(A) a sealant layer, wherein said sealant layer comprises LLDPE; and/or
(B) an OTR-reducing barrier layer, wherein said OTR-reducing barrier layer comprises metallized PET or metallized BoPA; and/or or BoPA co-ex, or a combination of both;
(C) an FCR-improving layer; wherein said FCR-improving layer comprises EVOH coex.

46. The flexible bag, as recited in claim 35, comprising one of the following products: (A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent.
